(19) United States
(12) Patent Application Publication
(10) Pub. No.: US 2025/0165890 A1
(43) Pub. Date: May 22, 2025

(54) AUTOMATED SOFTWARE DEVELOPMENT WORKFLOWS VIA MULTI-AGENT COMPUTATIONAL FRAMEWORK

(71) Applicant: Twilio Inc., San Francisco, CA (US)

(72) Inventor: Wesley Medford, San Francisco, CA (US)

(21) Appl. No.: 18/754,624

(22) Filed: Jun. 26, 2024

Related U.S. Application Data
(60) Provisional application No. 63/602,219, filed on Nov. 22, 2023.

(51) Int. Cl. G06Q 10/0633; G06F 8/71; G06Q 10/0631

(52) U.S. Cl. CPC G06Q 10/0633; G06F 8/71; G06Q 10/063118

(57) ABSTRACT

The disclosure presents a multi-agent AI system utilizing specialized Large Language Models (LLMs) to automate and enhance software development workflows. This system integrates a memory-augmented generative pre-trained transformer (MemGPT) agent for dynamic context management, a Critic Agent for semi-adversarial quality feedback, and other specialized agents for task delegation and execution. The MemGPT agent interacts with an embedding storage to manage extended contextual information, enabling the system to handle complex software projects with enhanced accuracy and efficiency. This innovative approach significantly reduces manual intervention, streamlines the development process, and improves software quality, offering a robust solution to the challenges of modern software development environments.

### RELATED APPLICATIONS

This application claims the benefit of and priority to U.S. Provisional Patent Application No. 63/602,219, with title, “AUTOMATED SOFTWARE DEVELOPMENT WORKFLOWS VIA MULTI-AGENT COMPUTATIONAL FRAMEWORK,” filed on Nov. 22, 2023, which is hereby incorporated by reference in its entirety for all purposes.

### TECHNICAL FIELD

The present application pertains to the technical field of artificial intelligence (AI) and software development automation. More specifically, the innovations described herein relate to the application of multi-agent computational systems, including large language models (LLMs) and memory-augmented language models such as MemGPT, to automate complex software engineering workflows. These systems are designed to replicate and enhance the roles within software engineering teams, such as engineers, planners, and critics, through intelligent task delegation, context management, and integration with existing software development tools, thereby streamlining the development process and improving efficiency and output quality.

### BACKGROUND

Software development is a multifaceted discipline that involves the collaboration of various specialists including product managers, software engineers, and quality assurance personnel. These teams work together to translate complex requirements into functional software applications. The process encompasses several stages, including planning, coding, testing, and maintenance. Each stage requires precise coordination and significant manual effort, often involving repetitive tasks and extensive communication among team members.

In modern software development practices, various tools and methodologies such as Agile frameworks, version control systems like Git, and continuous integration/continuous deployment (CI/CD) pipelines are employed to enhance efficiency and collaboration. These tools support the developers in managing changes, automating testing, and ensuring that software can be reliably released at any time.

Despite these advancements, the software development process remains labor-intensive and time-consuming. Developers must frequently switch contexts between different tools and tasks, which can lead to inefficiencies and increased potential for errors. Moreover, the growing complexity of software projects demands that team members possess high levels of technical expertise and the ability to quickly adapt to new technologies.

Additionally, the iterative nature of software development often requires that previously made decisions be revisited and revised, which can further complicate project management and increase the workload on developers. As software systems become more integrated and reliant on diverse technologies and frameworks, the challenge of managing such complex development environments continues to grow.

### BRIEF DESCRIPTION OF THE DRAWINGS

Embodiments of the present invention are illustrated by way of example and not limitation in the figures of the accompanying drawings, in which:

FIG. 1 is a diagram illustrating a process for creating embeddings—that is, vector representations—of a customer codebase, documentation for a software application, and customer documentation, which may then be utilized by a MemGPT agent to enhance the agent-based system's “understanding” and interaction with customer data for improved software development automation, consistent with some embodiments.

FIG. 2 depicts an agent-based system where individual agents, such as the Planner Agent, Engineer Agent, and Critic Agent, interact and coordinate in response to an initial user request or instruction provided via a prompt, demonstrating the dynamic workflow and communication within the system, according to some examples.

FIG. 3 illustrates an iterative development loop enabled by integration with a code repository, where the MemGPT and Engineer agents commit code that is executed, feedback is incorporated, and relevant commit data is stored into embeddings, demonstrating a continuous cycle of improvement and adaptation in the software development process, consistent with some embodiments.

FIG. 4 is diagrammatic representation of a computing device (e.g., a machine) within which instructions for causing the computing device to perform any one or more of the methodologies discussed herein may be stored and executed.

FIG. 5 is a block diagram illustrating a software architecture, which can be installed on any one or more of the devices described herein.

### DETAILED DESCRIPTION

Described herein are systems and methods for an advanced multi-agent artificial intelligence (AI) system designed to autonomously execute complex software engineering tasks, such as implementing customer data platforms. This innovative framework leverages specialized Large Language Models (LLMs) including a memory-augmented generative pre-trained transformer (MemGPT) agent, which dynamically manages extended context by interacting with an embedding storage. This interaction enhances the system's ability to perform context-aware operations effectively. The framework is further enriched with a Critic Agent that provides semi-adversarial feedback to enhance output quality, a Planner Agent for strategic task identification and delegation, an Engineer Agent responsible for precise code generation, and an Executor Agent that executes and tests the code. Each agent is provided with access to large knowledge bases like code repositories and documentation, overcoming traditional context window limitations of LLMs. Integration with development tools such as Aider and GitHub facilitate seamless interactions with software code repositories and version control and continuous integration pipelines, significantly improving the efficiency and quality of software development workflows. It will be evident to one skilled in the art that the present invention may be practiced and/or implemented with varying combinations of these features and additional details presented herein.

The field of software development is fraught with challenges that stem from the inherent complexity and resource-intensive nature of translating intricate requirements into functional software systems. Traditional development processes often involve multiple stages, each requiring significant manual effort and coordination among various specialists, including developers, project managers, and quality assurance teams. This not only leads to inefficiencies but also increases the potential for errors, thereby extending development timelines and escalating costs.

One of the primary challenges in contemporary software development is the limited context awareness of existing tools, particularly when dealing with large and complex codebases. LLMs, while powerful, are traditionally constrained by their context window limitations. This restricts their ability to “understand” and manipulate extensive codebases effectively, leading to suboptimal coding suggestions and increased manual oversight by human developers. Moreover, the iterative nature of software development, which often requires revisiting and revising previously made decisions, adds another layer of complexity and potential for inefficiency.

Additionally, the integration of software development tools with existing systems and workflows remains cumbersome. Tools like version control systems and continuous integration pipelines are essential for modern software development practices; however, their integration is not always seamless and often requires significant manual configuration and maintenance. This not only slows down the development process but also poses a barrier to achieving continuous deployment and integration, which are important for maintaining the agility of development teams in a competitive market.

Furthermore, the quality assurance process in software development is another area fraught with challenges. Traditional methods often rely heavily on manual testing, which is not only time-consuming but also prone to human error. The lack of automated, intelligent systems that can provide real-time, context-aware feedback on the quality of code and the overall plan further exacerbates the issue, leading to potential delays and increased costs due to bugs and other quality issues being identified late in the development cycle.

Described herein are techniques that aim to address these multifaceted challenges. Consistent with some embodiments, a multi-agent AI system that leverages specialized LLMs to automate and enhance various aspects of the software development workflow is provided. By integrating agents such as a memory-augmented generative pre-trained transformer (MemGPT) for dynamic context management, a Critic Agent for semi-adversarial quality feedback, and other specialized agents for task delegation and execution, the system significantly reduces the need for manual intervention, enhances the efficiency of the development process, and improves the quality of the software produced. This innovative approach not only streamlines the development process but also aligns with the evolving needs of modern software development environments, providing a robust solution to the limitations of the prior art.

In one aspect, the techniques described herein represent an improvement in the field of software development by introducing a sophisticated multi-agent AI system designed to automate and streamline complex software engineering tasks. This system is built around a group of specialized LLMs that operate in concert to mimic and enhance the collaborative efforts typically seen in human engineering teams, with each LLM, as an automated agent, playing a specialized role in the overall process.

The operation of a multi-agent AI system involves the coordination of multiple instances of Large Language Models (LLMs), each tailored with specific system prompts that define their roles within the broader framework. These system prompts are crafted to encapsulate the unique responsibilities and operational contexts of each agent, effectively guiding the LLMs to perform specialized tasks. By providing distinct prompts to each LLM, the overall system ensures that each LLM can focus on a narrower set of functions or tasks, which enhances their performance and accuracy. This specialization allows each agent to excel in its respective areas, such as planning, coding, testing, or quality assurance, contributing to a more efficient and effective overall system.

In this structured multi-agent setup, the output of one agent often becomes a part of the input for another, creating a seamless flow of information and tasks across the system. For instance, the Planner Agent might generate a detailed project plan based on initial requirements and strategic objectives, as specified by a user. The output from the Planner Agent, which may include specific tasks and timelines, is first reviewed by the Critic Agent. The Critic Agent evaluates the plan for coherence, robustness, and alignment with strategic goals, providing feedback and suggestions for improvement. Once refined, this plan is then provided as input to the Engineer Agent. The Engineer Agent uses the optimized plan to guide the code development process, ensuring that all software components are built according to the specified requirements. This inter-agent communication provides for maintaining coherence and alignment throughout the development lifecycle, ensuring that each phase of the project builds logically on the previous one.

An example of a system prompt for the Critic Agent might be: “Review the proposed software module for compliance with the specified design patterns and performance benchmarks. Provide feedback on any discrepancies and suggest necessary revisions.” This prompt directs the Critic Agent to focus on evaluating the quality and adherence of the software modules to predefined standards, offering constructive feedback that can be used to refine the product. By having such focused prompts, each LLM agent operates within a well-defined scope, enhancing the system's overall efficiency and reducing the likelihood of errors that might arise from broader, less directed tasks.

Through these mechanisms, the multi-agent AI system not only automates complex software engineering tasks but also ensures that each component of the software is developed, reviewed, and tested with high precision and adherence to quality standards. This approach significantly streamlines the development process, reduces the need for extensive manual oversight, and aligns with the evolving demands of modern software projects, providing a robust and scalable solution to the challenges of traditional software development practices.

Consistent with some embodiments, one automated agent in the system is the MemGPT agent, a memory-augmented generative pre-trained transformer that dynamically manages extended context. The MemGPT agent enhances the capabilities of standard LLMs by dynamically managing a broader range of contextual information through interactions with an embedding storage. The primary function of MemGPT is to ensure that all relevant data, such as code snippets, software documentation, and project-specific documentation, are readily accessible and utilized appropriately by other agents within the system. By doing so, MemGPT allows the multi-agent AI system to maintain a deep and nuanced understanding of complex software projects, enabling more accurate and context-aware operations across various development tasks. This capability is particularly advantageous for handling large codebases and intricate documentation that traditional LLMs struggle with due to their inherent context window limitations. By interacting with an embedding storage, the MemGPT agent ensures that all relevant data is readily available and contextually appropriate, thereby enhancing the system's overall understanding and operational efficiency.

The MemGPT agent operates by continuously interfacing with an embedding storage, which houses embeddings (e.g., vector representations) of diverse data types such as code snippets, comprehensive software documentation, and project-specific documentation. This embedding storage acts as a dynamic repository that the MemGPT agent queries to retrieve contextually relevant information. When a specific agent within the system, such as the Engineer Agent, requires data to perform its tasks, the MemGPT agent assesses the current context window of that agent and pulls the necessary embeddings from the storage. It processes these embeddings to extract and construct the precise context needed, effectively expanding the limited context window that traditional LLMs are constrained by. This capability allows the MemGPT agent to provide real-time, tailored context to each agent, ensuring that the information it delivers is both relevant and immediately applicable to the task at hand. By dynamically managing and supplying these extended contexts, the MemGPT agent significantly enhances the operational efficiency and accuracy of the multi-agent system, enabling it to handle complex software development tasks with a nuanced understanding that goes beyond the capabilities of standard LLMs.

Complementing the MemGPT agent are several other specialized agents, each designed for specific roles within the software development lifecycle. A Critic Agent provides semi-adversarial feedback, critically assessing both plans and code generated by other agents to ensure high quality and adherence to standards. The Planner Agent takes charge of task delegation, organizing the workflow and ensuring that all activities are aligned with the project's goals. The Engineer Agent is responsible for the actual code generation, translating the plans into functional software scripts. Lastly, the Executor Agent runs and tests the code, providing feedback on performance and identifying any potential issues.

An example of how this system operates can illustrate its effectiveness: Initially, a human user inputs a prompt into the system, specifying the need to implement a new feature into their software product. This user-provided prompt sets the overall task or objective for the system. Responding to this input, the Planner Agent develops a comprehensive plan based on these initial requirements. This plan is subsequently reviewed by the Critic Agent, which assesses its robustness and efficiency, suggesting any necessary improvements. Once the plan is refined and optimized, the Engineer Agent proceeds to generate the required code, which is then executed by the Executor Agent in a controlled test environment to ensure its functionality and integration. Throughout this entire process, the MemGPT agent plays a crucial role by ensuring that all agents are operating with a complete understanding of the project's context, actively pulling in necessary data from the embedding storage as needed to inform and guide the actions of the other agents.

In scenarios where the task involves modifying existing code, the system seamlessly integrates with a code repository to manage and track changes effectively. When the Engineer Agent identifies the need to alter existing software components, it accesses the relevant code directly from the code repository, which serves as a centralized archive for all versions of the software project. After retrieving the necessary code, the Engineer Agent implements the modifications as dictated by the optimized plan. These changes are then tested by the Executor Agent in a controlled environment to ensure they meet the required standards and do not introduce new issues. Upon successful validation, the updated code is committed back to the code repository, not merely as an addition but as a new, versioned iteration of the software. This version control mechanism is important as it maintains a historical record of all changes, allowing for easy rollback to previous versions if needed and providing a clear audit trail of development progress. By integrating with a code repository, the system enhances its capability to not only develop new code but also refine existing codebases, ensuring that every iteration is an improvement and accurately documented within the project's lifecycle.

This automated, intelligent workflow significantly reduces the need for manual intervention, speeds up the development process, and improves the overall quality of the software produced. By integrating seamlessly with existing tools like version control systems (e.g., GitHub, or Git), the system also supports modern development practices such as continuous integration and deployment, further enhancing its utility and applicability in real-world scenarios.

To further illustrate the capabilities of this multi-agent AI system, consider a detailed example, where a company seeks to implement a Customer Data Platform (CDP) like Segment® from Twilio®. Initially, the user inputs a high-level task into the system, such as “Integrate Segment to enhance customer data analytics.” The Planner Agent analyzes this input and devises a strategic plan outlining the necessary steps for integration, including modifications to the existing codebase and the setup of data pipelines. The effectiveness of the Planner Agent in this task is significantly enhanced by the MemGPT agent, which plays a role in providing access to the necessary contextual information, as stored in the embedding storage. For example, this information may include detailed documentation on implementing Segment, as well as documentation relating to software that has been deployed by the customer. The MemGPT agent, through its advanced memory-augmented capabilities, accesses an extensive embedding storage that contains vector representations of the company's existing codebase, documentation, and other relevant data.

The plan, as output by the Planner Agent, is then reviewed by the Critic Agent, which evaluates its feasibility and robustness, suggesting improvements or identifying potential issues. Once the plan is refined and approved, the Engineer Agent takes over, generating the required code to implement the CDP. This code is executed by the Executor Agent in a test environment to ensure it functions correctly and integrates seamlessly with the existing systems. Throughout this process, the MemGPT agent provides the necessary contextual information from the embedding storage, ensuring all agents operate with a comprehensive understanding of the codebase and the project requirements.

Beyond the example implementation of a CDP, this system is versatile enough to handle a variety of other software development tasks. For instance, it can be used to add new features to an existing application. In such a case, the Planner Agent would develop a plan based on the specifications of the new feature, the Critic Agent would ensure the plan aligns with the overall project architecture and existing functionalities, and the Engineer and Executor Agents would develop and test the new feature, respectively.

Another application of this system is in bug detection and resolution. When a bug is reported, the Planner Agent can outline steps for debugging, which are then scrutinized by the Critic Agent. The Engineer Agent would adjust the code to fix the bug, and the Executor Agent would validate the fix. This ensures that any modifications maintain the integrity and performance of the application while correcting the identified issue.

Additionally, the system can facilitate the continuous improvement of software products by enabling the integration of user feedback into the development cycle. For example, if users request an enhancement or report usability issues, the system can quickly adapt the development workflow to incorporate these insights, ensuring that the software evolves in alignment with user needs and expectations.

Accordingly, this multi-agent AI system not only streamlines the initial development of complex software solutions, such as integrating a CDP, but also enhances ongoing maintenance and expansion efforts. By automating routine tasks and providing intelligent, context-aware support, it allows development teams to address a wide range of challenges efficiently—from rolling out new features and functionalities to ensuring robustness and reliability through continuous testing and optimization. This adaptability makes it an invaluable tool across various stages of the software lifecycle, driving faster innovation and higher quality outputs. Other aspects and advantages of the various embodiments will be readily apparent from the description of the several figures that follow.

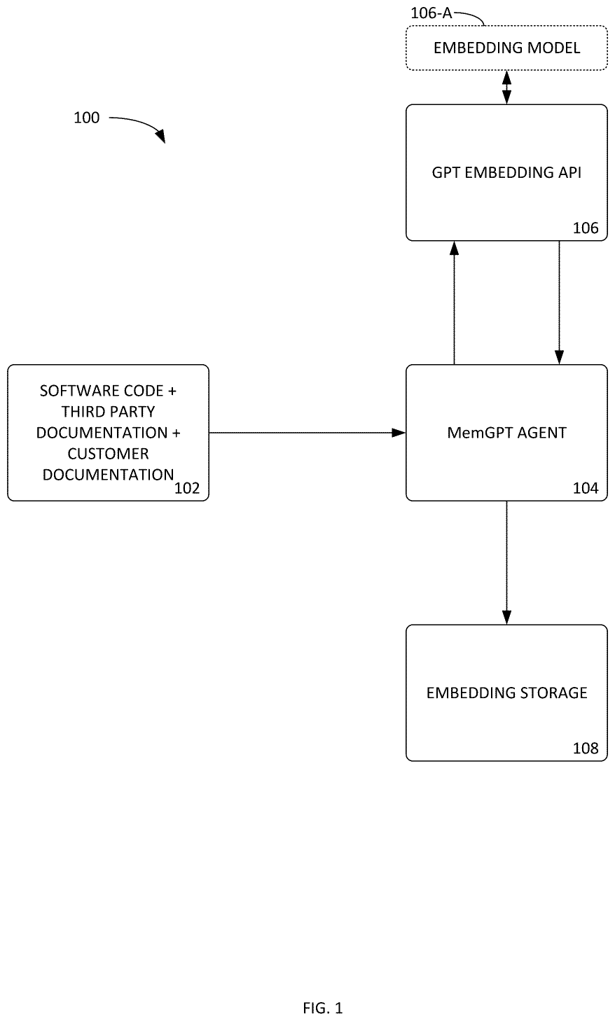

FIG. 1 is a diagram illustrating a process 100 for creating embeddings—that is, vector representations—of a customer codebase, documentation for a software application or system, and customer-specific documentation, which may then be utilized by a MemGPT agent 104 to enhance the agent-based system's “understanding” and interaction with customer data for improved software development automation, consistent with some embodiments. The process 100 begins with the collection of data 102 from three primary sources: the customer codebase, documentation for a software application, and customer documentation. The code base is extracted from a code repository, encompassing source code files, configuration files, and relevant scripts. Concurrently, related documentation, including README files, API documentation, design documents, and user manuals, is gathered. This ensures that both the code and its accompanying explanatory texts are included in the embedding generation process 100, as each of these content sources 102 plays a role in feeding the necessary raw data into the system for embedding creation.

Data from these three data sources are processed by the GPT Embedding API 106 which deploys a pre-trained embedding model 106-A responsible for converting the raw textual data into vector representations, or embeddings. The pre-trained embedding model 106-A, accessible via the API 106, analyzes the input text, extracts relevant features, and transforms these into a high-dimensional space where similar items are positioned in the embedding space closely together. This transformation enables the MemGPT agent 104 to “understand” the semantics of the data beyond mere keyword matching.

Once the data is collected, it undergoes preprocessing to prepare it for embedding generation. The code and documentation are tokenized into smaller chunks suitable for embedding generation. This tokenization is sensitive to the specific characteristics of different programming languages and natural languages. Subsequently, the text is normalized by converting it to lowercase, removing stop words, and applying stemming or lemmatization where appropriate. In the case of code, comments and non-functional text are removed to focus on the functional parts of the code.

With the preprocessed data ready, the MemGPT agent 104 integrates with the GPT embedding API 106. In some examples, the GPT embedding API 106 is accessed using RESTful calls or other supported protocols. Preprocessed text chunks are sent to the GPT embedding API 106 in batches to optimize performance. The GPT embedding API 106 processes these chunks and returns embeddings, which are high-dimensional vectors representing the semantic content of the text. This batch processing handles API rate limits and errors gracefully, ensuring robust and efficient embedding generation.

The embeddings received from the GPT embedding API 106 are then stored in an embedding storage 108. This storage system 108 can be a vector database or a traditional database with vector support. The embedding storage system 108 is chosen based on its ability to handle high-dimensional vectors and support efficient retrieval. A schema is designed for storing embeddings, including metadata such as file names, line numbers, and embedding vectors. The embeddings are inserted into the storage system 108 along with their metadata, allowing for precise identification and retrieval.

Consistent with some examples, post-processing and optimization steps enhance the functionality of the stored embeddings. Indexes may be created on the embedding vectors to facilitate fast similarity searches. Clustering algorithms, such as K-means or DBSCAN, may be applied to group similar embeddings, identifying related pieces of code and documentation. Additional metadata, such as code dependencies, function names, and documentation sections, are associated with the embeddings to enrich the retrieval and analysis capabilities.

The stored embeddings 108 enable a range of advanced features. Similarity search allows the MemGPT agent 104 to retrieve code snippets or documentation sections based on a query embedding, significantly improving the efficiency of finding relevant information. Code recommendation systems can suggest relevant code snippets or documentation based on the developer's current context, enhancing productivity and reducing errors. Knowledge graph construction links related code and documentation sections, providing better visualization and navigation of the software project.

The disclosed system illustrated in FIG. 1 is designed to be scalable, ensuring it can handle large code bases and documentation sets. The embedding storage 108 supports horizontal scaling through sharding and replication. Performance optimization includes batch processing and parallel API calls to reduce latency, along with efficient indexing and search algorithms for fast retrieval. Security is ensured through authentication and encryption of API calls, as well as access controls and encryption of stored embeddings.

Consistent with some examples, the disclosed system, including MemGPT agent 104, provides a comprehensive solution for generating, storing, and utilizing embeddings for software code bases and related documentation. By leveraging a GPT embedding API 106 and a specialized embedding storage 108, the MemGPT agent 104 enhances the manageability and navigability of large software projects, offering advanced features such as similarity search, code recommendation, and knowledge graph construction. This innovative approach addresses the challenges of traditional search methods, significantly improving the efficiency and effectiveness of software development and maintenance.

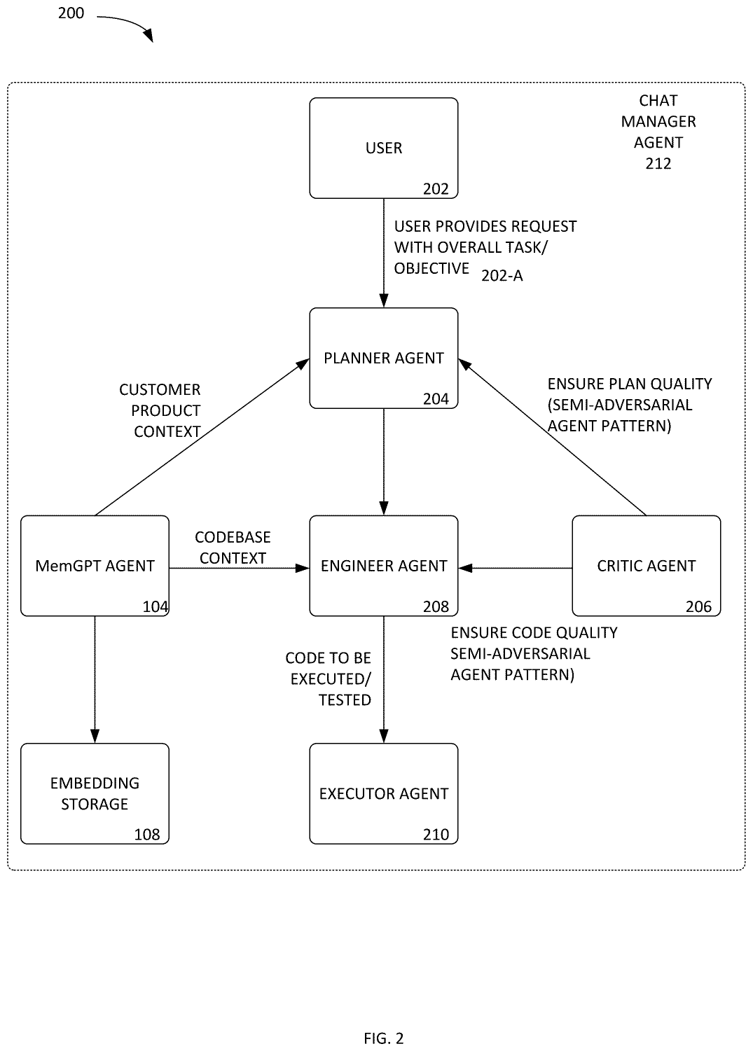

FIG. 2 depicts an agent-based system 200 where individual agents, such as the Planner Agent 204, Engineer Agent 208, and Critic Agent 206, interact and coordinate in response to an initial user request 202-A or instruction provided via a text entry or input prompt, demonstrating the dynamic workflow and communication within the system 200, according to some examples. The system 200 illustrated in FIG. 2 exemplifies how the various components collaborate to automate and enhance software development processes. The system 200 comprises multiple specialized agents, each with distinct roles, collaborating to achieve the overall task or objective provided by the user.

In the example system 200 illustrated in FIG. 2, the chat manager agent 212, functions as a router, managing the flow of information between the various specialized agents. As depicted in FIG. 2, the chat manager agent 212 is depicted as if executing in the background to illustrate that the chat manager agent 212 receives the output from each agent and intelligently formulates it as the input for the next agent in the workflow. For instance, the output generated by the Planner Agent 204, such as a detailed project plan, is routed by the chat manager agent 212 to the Engineer Agent 208 to be transformed into executable code. Subsequently, this code is passed to the Executor Agent 210, by the chat manager agent 212, for testing and validation. The chat manager agent 212 seamlessly facilitates these transitions, ensuring that the output of one agent is provided as the input needed by another, optimizing the workflow continuity and efficiency. In the example of FIG. 2, the arrows connecting the agents in the diagram serve as an illustrative example of this process; however, in various alternative implementations or uses cases, the flow and sequence of information may differ from what is specifically illustrated, depending on the dynamic requirements and conditions of the project at hand. This flexibility allows the chat manager agent 212 to dynamically adapt the information routing, tailoring the process to best suit the specific needs of the workflow and the project objectives.

Consistent with some embodiments, the functionality of the chat manager agent 212, as the central orchestrator of communication and task delegation among various specialized agents, can be effectively facilitated by several existing agent-based frameworks, including AutoGen. Autogen is a software framework designed to facilitate the management and coordination of multiple agent-based interactions within complex systems, optimizing task delegation and communication flow. AutoGen provides support for managing multi-agent interactions, making it a suitable platform for implementing the chat agent's routing capabilities. In addition to AutoGen, other popular LLM based agent frameworks that could similarly support the chat agent include LangChain, AutoGPT and BabyAGI. These frameworks offer agent-based processing capabilities and are well-suited for handling complex workflows involving multiple agents. Each framework provides unique features that can enhance the chat agent's ability to dynamically route tasks and manage communications based on the evolving needs of the software development process, ensuring that each agent operates efficiently and that the system as a whole functions as desired.

The initialization of the multi-agent AI system involves generating a unique system prompt for each agent, which precisely defines the role and operational scope of that agent within the system 200. These system prompts configure the underlying LLMs that each agent utilizes, tailoring them to perform specific functions effectively. For instance, the Planner Agent 204 might receive a system prompt that focuses it on strategic planning and task allocation, while the system prompt for the Engineer Agent 208 would orient it towards code generation and application development. Accordingly, this ensures that each agent not only understands its role but is also equipped with the necessary context and directives to execute its tasks efficiently.

Upon initialization, each agent operates within a defined context window, receiving inputs that are relevant to its specific function. The system prompts play a role here, as they guide the LLMs in processing these inputs to produce the desired outputs. For example, when the Planner Agent 204 receives an initial user request or task description, its system prompt helps it to analyze this information and develop a comprehensive action plan. This plan is then communicated to the next agent via routing performed by the chat manager agent 212. Accordingly, the output of the Planner Agent may be routed to the Engineer Agent 208, whose system prompt enables it to transform the plan into executable code. This structured flow of information, guided by carefully crafted prompts, ensures that each agent contributes effectively to the overall workflow, allowing the system to handle complex software development tasks dynamically and efficiently. Before any user can instruct the system with a specific software development task, each agent is correctly initialized with its respective system prompt, ensuring all agents are aligned and ready to function as an integrated unit.

The MemGPT Agent 104 functions within the multi-agent AI system by managing and retrieving relevant embeddings from the Embedding Storage 108. This functionality ensures that each agent operates with the most pertinent and contextually appropriate information. When the Chat Manager Agent 212 is tasked with generating inputs, such as LLM prompts for the various specialized agents, it relies on the MemGPT Agent 104 to provide the necessary context. This process involves the MemGPT Agent 104 querying the Embedding Storage 108 to fetch embeddings that encapsulate the required data, such as specific code snippets, documentation references, or project details relevant to the current task.

In practice, suppose the system is tasked with enhancing a software module. The Chat Manager Agent 212, in preparing to generate the input prompt for the Engineer Agent 208, would request the MemGPT Agent 104 to supply relevant context from the Embedding Storage 108. The MemGPT Agent 104 would then access the storage, retrieve embeddings related to the software module in question—perhaps including past versions of the module, associated documentation, and recent bug reports—and provide these embeddings to the Chat Manager Agent 212. This enriched context allows the Chat Manager Agent 212 to formulate a precise and informed prompt for the Engineer Agent 208, who then uses this information to effectively modify or enhance the software module. This example illustrates how the MemGPT Agent 104 ensures that each agent is equipped with the necessary context to perform its tasks accurately and efficiently, thereby enhancing the overall productivity and effectiveness of the system.

The Planner Agent 204 acts as the central coordinator for performing the user-specified task, analyzing the user-specified task to understand its scope and requirements. To achieve this, the Planner Agent 204 leverages the capabilities of the MemGPT agent, which accesses the embedding storage to retrieve relevant data that aligns with the overall objective. This data might include similar past projects, code snippets, and documentation that provide insights into potential solutions or methodologies that could be effective for the current task.

With this enriched context provided by the MemGPT agent, the Planner Agent 204 develops a comprehensive plan that breaks down the main objective into manageable components. The Planner Agent in the multi-agent AI system 200 is implemented using an LLM that is specifically conditioned with a system prompt tailored to guide its planning functions. This system prompt encapsulates the operational directives and objectives that the Planner Agent 204 needs to follow, enabling it to generate detailed and actionable project plans based on the input it receives from the user or other agents. The system prompt for the Planner Agent 204 is designed to initiate and guide the planning process by focusing the LLM on organizing and structuring tasks effectively. For example, a typical system prompt for the Planner Agent, might be: “Develop a comprehensive implementation plan based on the specified software enhancement requirements. Ensure the plan includes detailed steps, resource allocation, and timelines that align with the project's goals and technical constraints.”

This prompt directs the Planner Agent 204 to consider all aspects of the project, from technical requirements to resource management, and to organize these elements into a coherent plan. The prompt ensures that the Planner Agent 204 maintains a focus on the end goals of the project, facilitating a structured approach to task delegation among the other agents in the system, such as the Engineer Agent 208 for code development and the Critic Agent 206 for quality assurance.

By using such a system prompt, the Planner Agent 204 is able to leverage the computational power and contextual understanding capabilities of the LLM to produce plans that are not only detailed and comprehensive but also aligned with the strategic objectives of the software development project. This method of implementation allows the Planner Agent 204 to function as an effective coordinator within the multi-agent system 200, enhancing the overall efficiency and output quality of the software development process.

The Engineer Agent 208 of the multi-agent AI system is primarily responsible for the translation of detailed project plans into executable software code. This agent is specifically designed to handle the complexities of code generation, ensuring that the software not only meets the functional requirements outlined in the project plan but also adheres to best practices in coding standards. The system prompt for the Engineer Agent 208 is crafted to focus its operations on interpreting plans, understanding technical specifications, and converting these elements into high-quality, deployable code.

Upon receiving a project plan from the Planner Agent 204, the Engineer Agent 208 initiates its task by leveraging its system prompt and the contextual information supplied by the MemGPT Agent 104 to process the inputs (e.g., the context window) to generate output in the form of executable software code. This process may involve generating output in the form of new software code, refining existing codebases, or seamlessly integrating various software modules. The system prompt ensures that the operations of the Engineer Agent are precisely aligned with the project's objectives, emphasizing technical accuracy, efficiency, and the scalability of the software solution, thereby producing code that is robust and fit for purpose. For instance, if the project involves developing a new feature for an existing application, the system prompt of the Engineer Agent 208 might direct it to review the current architecture of the software application, identify the best integration points for the new feature, and generate the necessary code to implement the feature seamlessly. The prompt might also instruct the Engineer Agent 208 to consider performance implications and future maintenance needs, ensuring that the code is not only functional but also optimized for long-term operation.

The effectiveness of the Engineer Agent 208 is further enhanced by its interaction with the MemGPT Agent 104, which provides it with access to a rich set of embeddings from the Embedding Storage 108. These embeddings might include code snippets, API documentation, and other technical resources that are relevant to the task at hand. By leveraging this information, the Engineer Agent 208 can ensure that its code generation is informed by the best available knowledge and practices, leading to more robust and reliable software outputs.

Once the code is generated, the Engineer Agent 208 passes it along to the next agent in the workflow, via the chat manager agent 212. In many instances, the next agent is typically the Executor Agent 210 or the Critic Agent 206, depending on the system configuration. This transition is facilitated by the Chat Manager Agent 212, which ensures that the newly generated code is appropriately reviewed for quality and functionality before being deployed or tested. This systematic flow ensures that each piece of code is not only functionally accurate but also meets the quality standards set forth by the project requirements.

The Critic Agent 206 in the multi-agent AI system functions as a semi-adversarial reviewer of both the plans generated by the Planner Agent 204 and the software code produced by the Engineer Agent 208. This agent is designed to ensure that all outputs adhere to the highest standards of quality and align with the project's objectives. The system prompt for the Critic Agent 206 is specifically tailored to instill an evaluative approach, enabling it to scrutinize and critique the work of other agents effectively.

The system prompt for the Critic Agent 206 might typically include directives such as “Evaluate the coherence, feasibility, and completeness of the project plan” and “Assess the quality, efficiency, and compliance of the code with established standards.” This prompt positions the Critic Agent 206 as a safeguard within the system 200, ensuring that every component of the project meets or exceeds the predefined criteria and expectations. It operates by receiving the project plan and the executable code as inputs, which it then analyzes to identify any potential flaws, inefficiencies, or deviations from the project specifications.

In its operation, the Critic Agent 206 leverages embeddings and contextual data provided by the MemGPT Agent 104, which are stored in the Embedding Storage 108. These embeddings might include historical data on similar projects, quality benchmarks, and detailed logs of previous critiques, which enrich the Critic Agent's ability to assess. By accessing these resources, the Critic Agent 206 can apply a deep and nuanced analysis, comparing current project components against a rich backdrop of related information.

For example, when evaluating a software module's code, the Critic Agent 206 might use embeddings related to known issues and common bugs in similar modules, enabling it to pinpoint potential problems that might not be immediately obvious. Similarly, when assessing a project plan, it might compare the plan against successful project trajectories stored within the embeddings to suggest enhancements or flag areas where the plan falls short.

The semi-adversarial nature of the Critic Agent 206 allows for maintaining a high standard within the project lifecycle. It not only checks for errors or issues but also challenges the assumptions and decisions made by other agents, fostering a dynamic of continuous improvement. After its review, the Critic Agent 206 provides detailed feedback, which can be used to refine the project plan or the code. This feedback loop is essential for iterative development processes, where each cycle aims to enhance the overall quality and effectiveness of the output.

In some embodiments, the output from the Critic Agent 206, which includes detailed critiques and feedback on the project plan or code, may be presented through a user interface to a user, such as a project manager or a lead developer. This interface allows the user to visually evaluate the critiques in context with the plan or code. By providing an interactive and accessible means for users to review the feedback, the system enables them to make informed decisions about necessary revisions or approvals. This direct involvement of the user adds an additional layer of oversight and ensures that the final outputs not only meet technical standards but also align with broader organizational goals and user expectations. This feature is particularly valuable in complex projects where strategic alignment and precision are critical, allowing for a more hands-on approach to managing the iterative development process.

Ultimately, the Critic Agent 206, guided by its system prompt and empowered by contextual embeddings from the MemGPT Agent 104, acts as a checkpoint within the system. It ensures that every element of the project is not only functional but also optimal and robust, aligning with the strategic goals and technical demands of the project. This role not only enhances the reliability of the system outputs but also drives the collective system towards excellence in software development practices.

The Executor Agent 210 plays a role in the multi-agent AI system by being responsible for the execution and testing of the software code generated by the Engineer Agent 208. This agent operates as the final verifier of the code's functionality before it is considered ready for deployment or further refinement. The primary function of the Executor Agent 210 is to execute the code in a controlled environment, simulate its operation, and validate its performance against predefined criteria and test cases.

The operation of the Executor Agent 210 involves loading the code into a testing environment, executing it, and monitoring its behavior for any unexpected errors or failures. This process ensures that any logical or runtime errors are caught early in the development cycle, which significantly reduces the cost and time required for later fixes. The system prompt for the Executor Agent 210 might include directives to assess the code's efficiency, security compliance, and compatibility with existing systems, ensuring comprehensive validation.

Once the code is executed, the Executor Agent 210 collects data on its performance, including execution logs, error reports, and output results. This data provides tangible feedback on the code's real-world operability. The Chat Manager Agent 212 then processes this output to determine the success of the execution. It analyzes the data to identify any errors or issues that occurred during the execution and assesses whether the code has met all operational benchmarks successfully.

Following the execution and initial evaluation by the Executor Agent 210, the results, including any execution logs, error reports, and performance data, are passed back to the Engineer Agent 208 via the Chat Manager Agent 212. This iterative feedback loop is crucial for refining and optimizing the code. The Engineer Agent 208 reviews the feedback to identify any necessary changes or improvements, and then adjusts the code accordingly. This process of revision and re-execution may repeat multiple times, with the Executor Agent 210 continuously verifying each new version of the code until it meets all specified requirements and performance benchmarks.

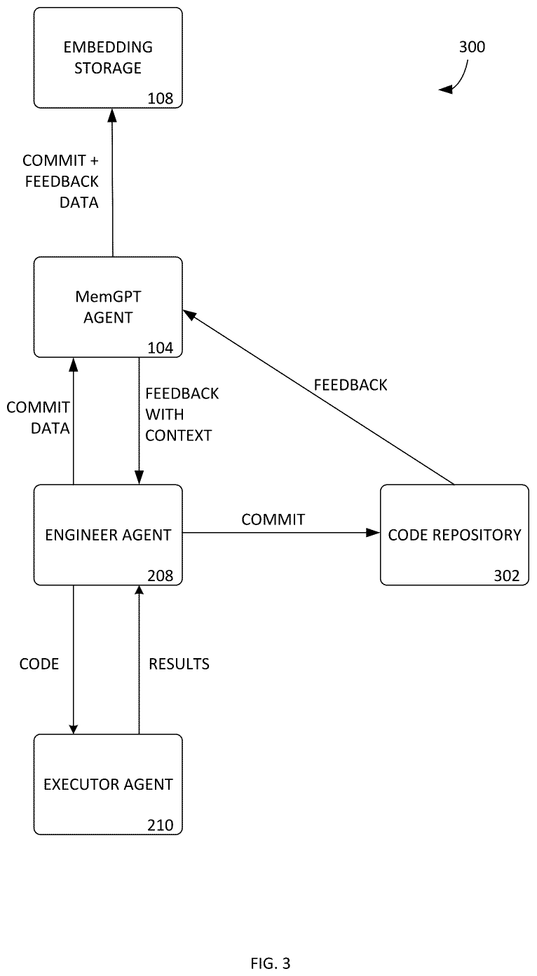

This iterative development process, facilitated by the Chat Manager Agent 212, ensures that the software code evolves into a robust and efficient final product, ready for deployment. Once the code successfully passes all tests and validations without any errors, it is deemed ready for a final commit to a code repository, such as Git. This final step formally integrates the tested and approved code into the project's main codebase, making it available for deployment or further integration with other system components. The detailed workflow of this process, including the interactions between the Engineer Agent 208, Executor Agent 210, and the Chat Manager Agent 212 leading to the final code commit, is illustrated in FIG. 3. This diagram provides a clear visual representation of the dynamic and collaborative nature of the code development and validation process within the multi-agent AI system.

The architecture and process described in FIG. 2 highlights the collaborative and semi-adversarial interactions among the agents. The Planner Agent 204 oversees the workflow, while the Engineer Agent 208 and Critic Agent 206 ensure plan and code quality through their respective roles. The Executor Agent 210 validates the implementation through rigorous testing. The MemGPT Agent 104, with its embedding capabilities, enhances the overall system by providing contextual intelligence and facilitating advanced analysis. By leveraging the unique capabilities of each agent and integrating advanced AI techniques, the system 200 ensures high-quality, efficient, and context-aware software development. This innovative approach addresses the complexities of modern software engineering, making the development process more robust and aligned with user and business objectives.

FIG. 3 illustrates an iterative development loop enabled by integration with a code repository 302, where the MemGPT Agent 104 and Engineer Agent 208 commit code that is executed, feedback is incorporated, and relevant commit data is stored into embeddings 108, demonstrating a continuous cycle of improvement and adaptation in the software development process, consistent with some embodiments.

The process begins with the Engineer Agent 208, which is responsible for generating and updating code based on the plans and feedback it receives. This agent 208 plays writes and revises the software code necessary to implement new features or fix existing issues within the software project.

Once the Engineer Agent 208 has prepared an update or new code, it commits these changes to the code repository 302. The code repository 302 serves as a central hub where all code changes are stored and managed. It allows for version control and tracking of changes, which is essential for collaborative development environments and for maintaining the integrity of the software project over time.

Following the code commit, the Executor Agent 210 automatically triggers a series of actions to test the new or updated code. This agent executes the code in a controlled environment to ensure that it performs as expected and to identify any new issues that the changes may have introduced. In part, the role of the Executor Agent is to verify the functionality and stability of the software before it is deployed to production environments.

Feedback from these tests is then analyzed by the MemGPT Agent 104, which plays a role in the learning and adaptation phase of the cycle. The MemGPT Agent 104 uses the feedback to update the embeddings stored in the Embedding Storage 108. These embeddings represent a distilled understanding of the codebase, documentation, and operational context of the software project, allowing the system to learn from past actions and improve future responses.

The updated embeddings are then utilized by the MemGPT Agent 104 to inform and refine the actions of the Engineer Agent 208 in subsequent iterations. This creates a feedback loop where each cycle of coding, testing, and feedback leads to improvements in the software's functionality and quality.

Accordingly, FIG. 3 depicts a dynamic and iterative process that enhances the software development lifecycle by integrating intelligent agents with traditional code repositories. This integration facilitates continuous improvement through automated testing, feedback analysis, and learning, ensuring that the software evolves to meet user needs and adapts to changing requirements efficiently.

In some alternative embodiments, the multi-agent AI system incorporates Aider, an advanced coding tool built on the GPT-4 model, which significantly enhances the system's capabilities in managing code revisions and interactions with version control systems, specifically Git. This integration aims to streamline the software development process by automating the management of code changes and facilitating a more dynamic and responsive development workflow.

Aider is designed to interact directly with Git repositories, allowing it to commit code changes, manage branches, and handle merge conflicts. This capability can be integrated into the system by enhancing the role of the Engineer Agent or by introducing a new specialized agent known as a Version Control Agent. The Version Control Agent would be specifically tasked with overseeing all version control operations, utilizing Aider to ensure that all code changes are accurately tracked and that the repository remains in a consistent and stable state.

The system prompt for the Version Control Agent would be configured to direct the agent to use Aider for executing version control commands. This prompt would include instructions for checking out branches, committing changes, merging branches, and pushing changes to remote repositories. The integration of Aider would allow the Version Control Agent to perform these tasks automatically, based on the outputs from other agents in the system, such as the Engineer Agent and the Critic Agent. For example, once the Engineer Agent develops new code or modifies existing code based on the project plan, the Version Control Agent would use Aider to commit these changes to the Git repository. Similarly, if the Critic Agent identifies issues or suggests improvements, the Version Control Agent could use Aider to revert changes or create new branches for further development.

Furthermore, the integration of Aider into the system enhances the feedback loop by providing real-time updates on the status of the code repository. Developers and project managers can use a user interface connected to Aider to view the commit history, current branches, and status of ongoing merges. This visibility into the version control process helps in making informed decisions about the direction of the project and facilitates a more collaborative and transparent development environment.

Accordingly, some alternative embodiments of the invention that integrate Aider into the multi-agent AI system represent a significant advancement in the automation of software development workflows. By leveraging Aider's capabilities in managing version control tasks through Git, the system not only improves the efficiency and responsiveness of the development process but also enhances the overall robustness and reliability of the software being developed. This embodiment ensures that the multi-agent AI system can adapt to changes quickly and maintain high standards of quality and consistency in the software development lifecycle.

### Machine Architecture

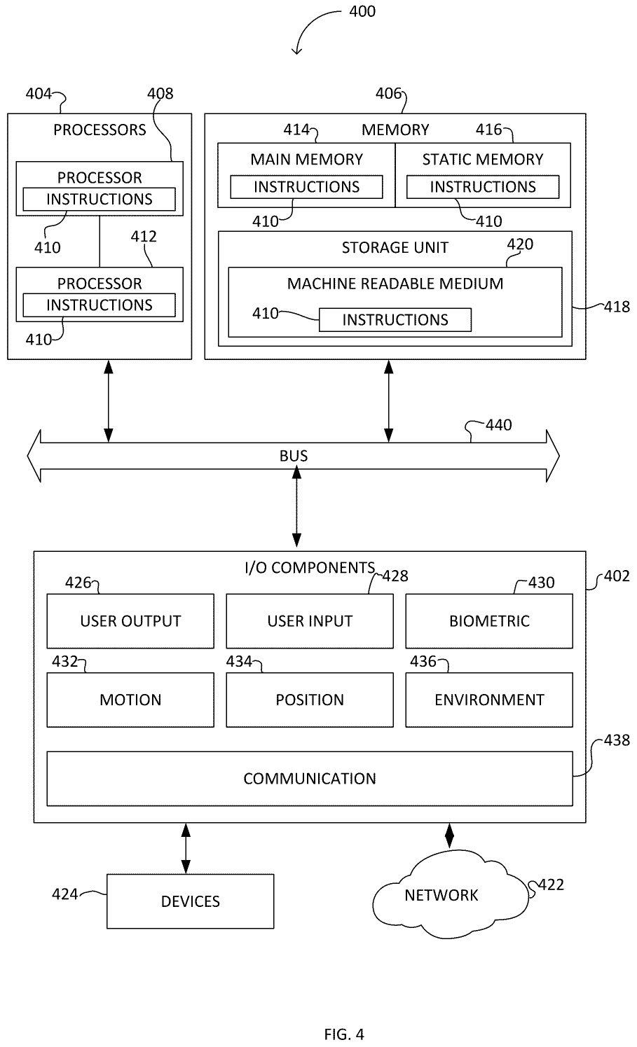

FIG. 4 is a diagrammatic representation of a machine 400—sometimes referred to as a computing device—within which instructions 410 (e.g., software, a program, an application or app, or other executable code) for causing the machine 400 to perform any one or more of the methodologies discussed herein may be executed. For example, the instructions 410 may cause the machine 400 to execute any one or more of the methods described herein. The instructions 410 transform the general, non-programmed machine 400 into a particular machine 400 programmed to carry out the described and illustrated functions in the manner described. The machine 400 may operate as a standalone device or may be coupled (e.g., networked) to other machines. In a networked deployment, the machine 400 may operate in the capacity of a server machine or a client machine (e.g., client computing device) in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while a single machine 400 is illustrated, the term “machine” shall also be taken to include a collection of machines that individually or jointly execute the instructions 410 to perform any one or more of the methodologies discussed herein. The machine 400, for example, may comprise the client machine(s) 310 or any one of multiple server devices forming part of the customer data platform 300. In some examples, the machine 400 may also comprise both client and server systems, with certain operations of a particular method or algorithm being performed on the server-side and with certain operations of the particular method or algorithm being performed on the client-side.

The machine 400 may include processors 404, memory 406, and input/output I/O components 402, which may be configured to communicate with each other via a bus 440. In an example, the processors 404 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 404 and a processor 412 that execute the instructions 410. The term “processor” is intended to include multi-core processors that may comprise two or more independent processors (sometimes referred to as “cores”) that may execute instructions contemporaneously. Although FIG. 4 shows multiple processors 404, the machine 400 may include a single processor with a single-core, a single processor with multiple cores (e.g., a multi-core processor), multiple processors with a single core, multiple processors with multiples cores, or any combination thereof.

The memory 406 includes a main memory 414, a static memory 416, and a storage unit 404, all accessible to the processors 404 via the bus 440. The main memory 406, the static memory 416, and storage unit 414 store the instructions 410 embodying any one or more of the methodologies or functions described herein. The instructions 410 may also reside, completely or partially, within the main memory 414, within the static memory 416, within machine-readable medium 420 within the storage unit 414, within at least one of the processors 404 (e.g., within the processor's cache memory), or any suitable combination thereof, during execution thereof by the machine 400.

The I/O components 402 may include a wide variety of components to receive input, provide output, produce output, transmit information, exchange information, capture measurements, and so on. The specific I/O components 402 that are included in a particular machine will depend on the type of machine. For example, portable machines such as mobile phones may include a touch input device or other such input mechanisms, while a headless server machine will likely not include such a touch input device. It will be appreciated that the I/O components 402 may include many other components that are not shown in FIG. 4. In various examples, the I/O components 402 may include user output components 426 and user input components 424. The user output components 426 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 424 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 402 may include biometric components 430, motion components 432, environmental components 436, or position components 434, among a wide array of other components. For example, the biometric components 430 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 432 include acceleration sensor components (e.g., accelerometer), gravitation sensor components, rotation sensor components (e.g., gyroscope).

The environmental components 436 include, for example, one or more image sensors or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 434 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 402 further include communication components 434 operable to couple the machine 400 to a network 422 or devices 424 via respective coupling or connections. For example, the communication components 434 may include a network interface component or another suitable device to interface with the network 422. In further examples, the communication components 434 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 424 may be another machine or any of a wide variety of peripheral devices (e.g., a peripheral device coupled via a USB).

Moreover, the communication components 434 may detect identifiers or include components operable to detect identifiers. For example, the communication components 44 may include Radio Frequency Identification (RFID) tag reader components. NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 434, such as location via Internet Protocol (IP) geolocation, location via Wi-Fi® signal triangulation, location via detecting an NFC beacon signal that may indicate a particular location, and so forth.

The various memories (e.g., main memory 414, static memory 416, and memory of the processors 404) and storage unit 414 may store one or more sets of instructions and data structures (e.g., software) embodying or used by any one or more of the methodologies or functions described herein. These instructions (e.g., the instructions 410), when executed by processors 404, cause various operations to implement the disclosed examples.

The instructions 410 may be transmitted or received over the network 422, using a transmission medium, via a network interface device (e.g., a network interface component included in the communication components 434) and using any one of several well-known transfer protocols (e.g., hypertext transfer protocol (HTTP)). Similarly, the instructions 410 may be transmitted or received using a transmission medium via a coupling (e.g., a peer-to-peer coupling) to the devices 424.

### Software Architecture

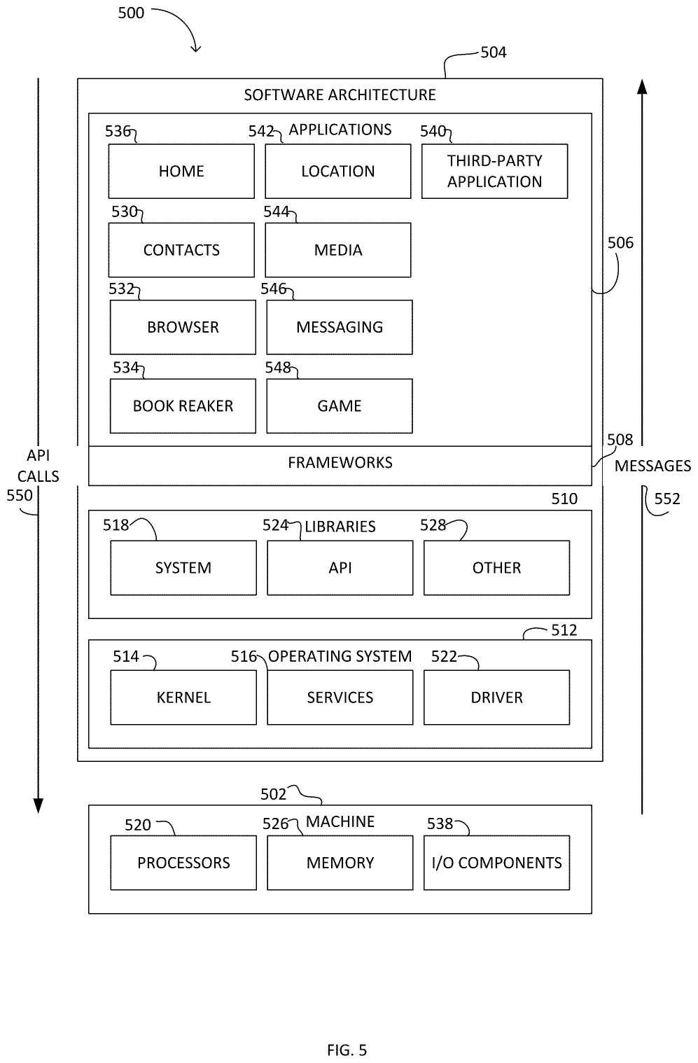

FIG. 5 is a block diagram 500 illustrating a software architecture 504, which can be installed on any one or more of the devices described herein. The software architecture 504 is supported by hardware such as a machine 502 that includes processors 520, memory 526, and I/O components 538. In this example, the software architecture 504 can be conceptualized as a stack of layers, where each layer provides a particular functionality. The software architecture 504 includes layers such as an operating system 512, libraries 510, frameworks 508, and applications 506. Operationally, the applications 506 invoke API calls 550 through the software stack and receive messages 552 in response to the API calls 550.

The operating system 512 manages hardware resources and provides common services. The operating system 512 includes, for example, a kernel 514, services 516, and drivers 522. The kernel 514 acts as an abstraction layer between the hardware and the other software layers. For example, the kernel 514 provides memory management, processor management (e.g., scheduling), component management, networking, and security settings, among other functionalities. The services 516 can provide other common services for the other software layers. The drivers 522 are responsible for controlling or interfacing with the underlying hardware. For instance, the drivers 522 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 510 provide a common low-level infrastructure used by the applications 506. The libraries 510 can include system libraries 518 (e.g., C standard library) that provide functions such as memory allocation functions, string manipulation functions, mathematic functions, and the like. In addition, the libraries 510 can include API libraries 524 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3). Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 510 can also include a wide variety of other libraries 528 to provide many other APIs to the applications 506.

The frameworks 508 provide a common high-level infrastructure that is used by the applications 506. For example, the frameworks 508 provide various graphical user interface (GUI) functions, high-level resource management, and high-level location services. The frameworks 508 can provide a broad spectrum of other APIs that can be used by the applications 506, some of which may be specific to a particular operating system or platform.

In an example, the applications 506 may include a home application 536, a contacts application 530, a browser application 532, a book reader application 534, a location application 542, a media application 544, a messaging application 546, a game application 548, and a broad assortment of other applications such as a third-party application 540. The applications 506 are programs that execute functions defined in the programs. Various programming languages can be employed to create one or more of the applications 506, structured in a variety of manners, such as object-oriented programming languages (e.g., Objective-C, Java, or C++) or procedural programming languages (e.g., C or assembly language). In a specific example, the third-party application 540 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 540 can invoke the API calls 550 provided by the operating system 512 to facilitate functionalities described herein.

What is claimed, is:

1. A computer-implemented system using an agent-based framework for automating software development workflows, the system comprising:
a memory-augmented generative pre-trained transformer (MemGPT) agent configured to dynamically manage extended context by interacting with an embedding storage to retrieve and store data representations;
a Critic Agent configured to provide semi-adversarial feedback on software development outputs generated by other agents within the system, the Critic Agent implemented using a large language model (LLM) conditioned by a system prompt specifically designed to instruct the LLM to evaluate and critique plans and code for adherence to predefined quality standards;
a plurality of specialized agents each configured with distinct roles in a software development process, wherein each agent is associated with a tailored system prompt that guides an LLM in generating role-specific outputs, the agents comprising:
a Planner Agent responsible for task delegation and high-level planning, configured to generate comprehensive project plans by processing inputs through an LLM conditioned to understand and organize project requirements into executable tasks;
an Engineer Agent responsible for code generation, configured to produce functional software code by interpreting plans and specifications through an LLM conditioned to apply software engineering principles and coding practices;
an Executor Agent responsible for executing and testing the generated code, configured to operate in a controlled environment and provide feedback on code performance and errors, utilizing an LLM to interpret execution results and suggest modifications or corrections;
wherein the MemGPT agent enhances the functionality of the system by allowing each agent to access a broader context than typically permissible by standard LLM context windows, thereby enabling more comprehensive understanding and interaction with complex software development tasks; and
wherein the Critic Agent serves as a semi-adversarial feedback mechanism that is integral to continuous improvement of the software development outputs, ensuring that each iteration adheres more closely to project specifications and quality metrics.

2. The computer-implemented system of claim 1, wherein the embedding storage is configured to store vector representations of code snippets and application documentation, and the MemGPT agent is further configured to update the embedding storage based on feedback from one or more agents.

3. The computer-implemented system of claim 1, wherein the system further comprises a user interface module configured to receive input from a user regarding project goals and parameters, and to display the generated project plans for user review and approval before task delegation to the Engineer Agent.

4. The computer-implemented system of claim 1, wherein the Engineer Agent is further configured to interact with a version control system to commit the generated code to a code repository, and the system further comprises a version control interface module configured to manage interactions between the Engineer Agent and the version control system.

5. The computer-implemented system of claim 1, wherein the agent-based framework is implemented using Autogen.

6. The computer-implemented system of claim 1, wherein the Critic Agent is further configured to utilize a feedback loop mechanism that incorporates user feedback into its semi-adversarial analysis, enhancing precision of its critiques based on real-world user interactions and responses.

7. The computer-implemented system of claim 1, wherein the Executor Agent is additionally configured to simulate different operating environments to test the generated code under various conditions, thereby ensuring robustness and compatibility across multiple platforms before deployment.

8. A method for automating software development workflows in a computer-implemented system with an agent-based framework, the method comprising:
implementing a plurality of specialized agents, each with a large language model (LLM) and a system prompt that specifies its role within the system for tasks including planning, critiquing, executing, and revising both project plans and software code;
receiving a user-specified task and routing this task to a Planner Agent to generate an initial plan;
dynamically routing the initial plan to a Critic Agent to critique the plan;
returning the critiqued plan to the Planner Agent for revisions;
upon approval of the revised plan, routing the revised plan to an Executor Agent to execute the revised plan and generate or revise software code;
routing the generated or revised software code to the Critic Agent for critique; and
committing the approved software code to a code repository, ensuring version control and maintenance within a collaborative software development environment;
wherein a context window for each agent's operation is enhanced by using a MemGPT agent to retrieve and incorporate relevant embeddings from an embedding storage into the prompts provided to each agent, thereby enriching the information basis for their operations and improving accuracy and relevance of their outputs.

9. The method of claim 8, wherein the embedding storage is configured to store vector representations of code snippets and application documentation, and the method further comprises updating the embedding storage based on feedback from one or more agents to refine the stored vector representations and improve contextual accuracy for future operations of the agents.

10. The method of claim 8, wherein the system further comprises a user interface module, and the method further comprises:
receiving input from a user via the user interface module regarding project goals and parameters;
displaying the generated project plans on the user interface for user review and approval;
upon user approval, routing the approved project plan to an Engineer Agent for task execution.

11. The method of claim 8, wherein an Engineer Agent is further configured to interact with a version control system, and the method further comprises:
managing interactions between the Engineer Agent and the version control system through a version control interface module;
committing the generated code by the Engineer Agent to a code repository via the version control system, ensuring that the code is properly version-controlled and stored.

12. The method of claim 8, wherein the agent-based framework is implemented using Autogen, and the method further comprises utilizing Autogen to manage and coordinate interactions and data flow between the specialized agents.

13. The method of claim 8, wherein the Critic Agent is further configured to utilize a feedback loop mechanism, and the method further comprises:
incorporating user feedback into a semi-adversarial analysis performed by the Critic Agent;
enhancing precision of the critiques provided by the Critic Agent based on real-world user interactions and responses, thereby aligning the software development outputs more closely with user expectations and requirements.

14. The method of claim 8, wherein the Executor Agent is additionally configured to simulate different operating environments, and the method further comprises:
testing the generated software code under various conditions by simulating different operating environments;
ensuring compatibility of the software code across multiple platforms before its final approval and deployment, thereby reducing risk of deployment failures and enhancing adaptability of the generated software code to diverse operational conditions.

15. A system for automating software development workflows with an agent-based framework, the system comprising:
at least one processor;
at least one memory storage device storing instructions thereon, which, when executed by the at least one processor, cause the system to perform operations comprising:
implementing a plurality of specialized agents, each with a large language model (LLM) and a system prompt that specifies its role within the system for tasks including planning, critiquing, executing, and revising both project plans and software code;
receiving a user-specified task and routing this task to a Planner Agent to generate an initial plan;
dynamically routing the initial plan to a Critic Agent to critique the plan;
returning the critiqued plan to the Planner Agent for revisions;
upon approval of the revised plan, routing the revised plan to an Executor Agent to execute the revised plan and generate or revise software code;
routing the generated or revised software code to the Critic Agent for critique; and
committing the approved software code to a code repository, ensuring version control and maintenance within a collaborative software development environment;
wherein a context window for each agent's operation is enhanced by using a MemGPT agent to retrieve and incorporate relevant embeddings from an embedding storage into the prompts provided to each agent, thereby enriching the information basis for their operations and improving accuracy and relevance of their outputs.

16. The system of claim 15, wherein the embedding storage is configured to store vector representations of code snippets and application documentation, and the operations further comprise updating the embedding storage based on feedback from one or more agents to refine the stored vector representations and improve contextual accuracy for future operations of the agents.

17. The system of claim 15, wherein the system further comprises a user interface module, and the operations further comprise:
receiving input from a user via the user interface module regarding project goals and parameters;
displaying the generated project plans on the user interface for user review and approval;
upon user approval, routing the approved project plan to an Engineer Agent for task execution.

18. The system of claim 15, wherein an Engineer Agent is further configured to interact with a version control system, and the operations further comprise:
managing interactions between the Engineer Agent and the version control system through a version control interface module;
committing the generated code by the Engineer Agent to a code repository via the version control system, ensuring that the code is properly version-controlled and stored.

19. The system of claim 15, wherein the agent-based framework is implemented using Autogen, and the operations further comprise utilizing Autogen to manage and coordinate interactions and data flow between the specialized agents.

20. The system of claim 15, wherein the Critic Agent is further configured to utilize a feedback loop mechanism, and the operations further comprise:
incorporating user feedback into a semi-adversarial analysis performed by the Critic Agent;
enhancing precision of the critiques provided by the Critic Agent based on real-world user interactions and responses, thereby aligning the software development outputs more closely with user expectations and requirements.
